(19) United States
(12) Patent Application Publication
(10) Pub. No.: US 2013/0111689 A1
(43) Pub. Date: May 9, 2013

(54) WINDSCREEN WIPER AND DEVICE FOR SECURING A SCREEN WASH PRODUCT SUPPLY DUCT ON AN ACTUATING ARM OF A WINDSCREEN WIPER BLADE

(71) Applicant: Valeo Systemes d'Essuyage, Le Mesnil Saint Denis (FR)

(72) Inventor: Philippe Picot, Les Ancizes Comps (FR)

(73) Assignee: VALEO SYSTEMES D'ESSUYAGE, Le Mesnil Saint Denis (FR)

(21) Appl. No.: 13/672,810

(22) Filed: Nov. 9, 2012

(30) Foreign Application Priority Data
Nov. 9, 2011 (FR) 1160179

(51) Int. Cl. B60S 1/52

(52) U.S. Cl. CPC B60S 1/524
USPC 15/250.04

(57) ABSTRACT

The present invention relates to a device for securing a screen wash product supply duct (56) on an actuating arm (12) of a windscreen wiper blade (20) of a motor vehicle, said securing device comprising a means (31; 31′) for fixing the supply duct (56), characterized in that it additionally comprises an elastic retaining stirrup (32; 32′) configured to cooperate with the outer periphery of a wiping pressure spring (28) housed in a cavity (26) of the housing part (14) of the actuating arm (12) or configured to be arranged around a wiping pressure spring (28) housed in a cavity (26) of the housing part (14) of the actuating arm (12) and configured to cooperate with the internal flanks of said cavity (26), in order to retain the supply duct (56) on the actuating arm (12). The present invention also relates to a windscreen wiper (10; 10′) comprising such a securing device (30; 30′).

The invention relates to a device for securing a screen wash product supply duct on an actuating arm of a windscreen wiper blade of a motor vehicle. The invention also relates to a windscreen wiper provided with said securing device.

The screen wash product supply duct is connected to a reservoir of the motor vehicle in order to supply spraying devices. It is known practice to run the flexible duct along the actuating arm in order to supply a washing liquid spraying device carried, for example, by a windscreen wiper blade mounted in an articulated manner at the free end of the arm. The flexible duct is secured, for example, by means of external clasps arranged around the actuating arm.

In order to optimally integrate the flexible duct with the windscreen wiper, it is also known practice to run the duct inside a wiping pressure spring housed in a cavity arranged in the actuating arm. Thus, the duct is concealed within the actuating arm and it is also better protected against the impacts and friction liable to damage it. In addition, thus housed in the spring, the duct is secured away from the windscreen to be wiped. However, due in particular to the flexibility of the supply duct, its insertion into the axial housing of the spring constitutes a difficult and complicated mounting operation.

In order to solve these problems as well as others, the invention provides a securing device making it possible to easily fix the supply duct to the windscreen wiper blade actuating arm while concealing the supply duct and securing it away from the windscreen to be wiped and from the grille of the vehicle.

Accordingly, the object of the present invention is a device for securing a screen wash product supply duct on an actuating arm of a windscreen wiper blade of a motor vehicle, said securing device comprising a means for fixing the supply duct, characterized in that it additionally comprises an elastic retaining stirrup configured to cooperate with the outer periphery of a wiping pressure spring housed in a cavity of the housing part of the actuating arm or configured to be arranged around a wiping pressure spring housed in a cavity of the housing part of the actuating arm and configured to cooperate with the internal flanks of said cavity, in order to retain the supply duct on the actuating arm.

According to one or more features of the securing device, taken alone or in combination:
the retaining stirrup comprises a first fork configured to fit elastically on the turns of the wiping pressure spring,
the retaining stirrup comprises an anti-rotation means,
the anti-rotation means is formed by at least a second fork which can cooperate with the internal flanks of the cavity by elastic deformation,
the securing device comprises two second forks, the first fork being longer than the second forks and the first fork being interposed between the two second forks,
said means for fixing the supply duct comprises a clip,
said securing device is produced as a single piece consisting of the retaining stirrup and of the means for fixing the supply duct,
said securing device has a length of more than ten millimetres.

Another subject of the invention is a windscreen wiper comprising a wiper blade actuating arm and a supply duct of a device for spraying screen wash product, characterized in that it comprises a securing device as described above at least partially housed in the cavity of the actuating arm, retaining the supply duct on the actuating arm.

According to a first aspect, the elastic retaining stirrup is fitted elastically around the end turns of the wiping pressure spring which are situated in the region of the rear end of said spring, said end being attached to the drive head of the windscreen wiper.

According to a second aspect, the elastic retaining stirrup is arranged around the end turns of the wiping pressure spring which are situated in the region of the rear end of said spring, said end being attached to the drive head of the windscreen wiper.

It is thus sufficient to fix the supply duct to the securing device and then to assemble the elastic retaining stirrup either by fitting it to the wiping pressure spring or by fitting it in the cavity of the housing part around the spring, in order to fix the supply duct to the actuating arm. Thus retained, the supply duct is concealed and protected by a simple, quick and inexpensive mounting.

The securing device additionally guides the supply duct away from the windscreen to be wiped during the wiping operation and away from the grille in the rest position, without having to implement a complicated operation of mounting the supply duct in the wiping pressure spring.

In addition, the diameter of the turns of the wiping pressure spring is very well controlled in terms of its geometry and its dimensions. A few models are sufficient to cover the majority of vehicle models. Therefore, in the case where the securing device cooperates with the wiping pressure spring, the securing device is versatile since it can be adapted to a large number of windscreen wipers of the range without requiring modification of the housing part of the actuating arm.

This description, given by way of non-limiting example, will give a better understanding of how the invention can be implemented, with reference to the appended drawings, in which:

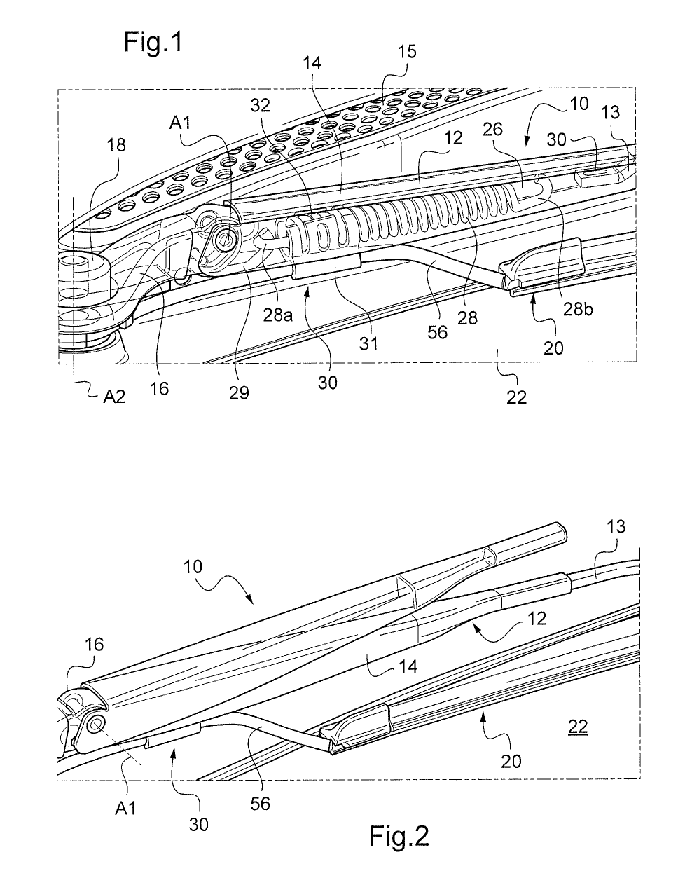

FIG. 1 represents a windscreen wiper mounted on a motor vehicle in the rest position, the drive head and the actuating arm being represented transparently,

FIG. 2 is a view of the windscreen wiper of FIG. 1 during the wiping operation,

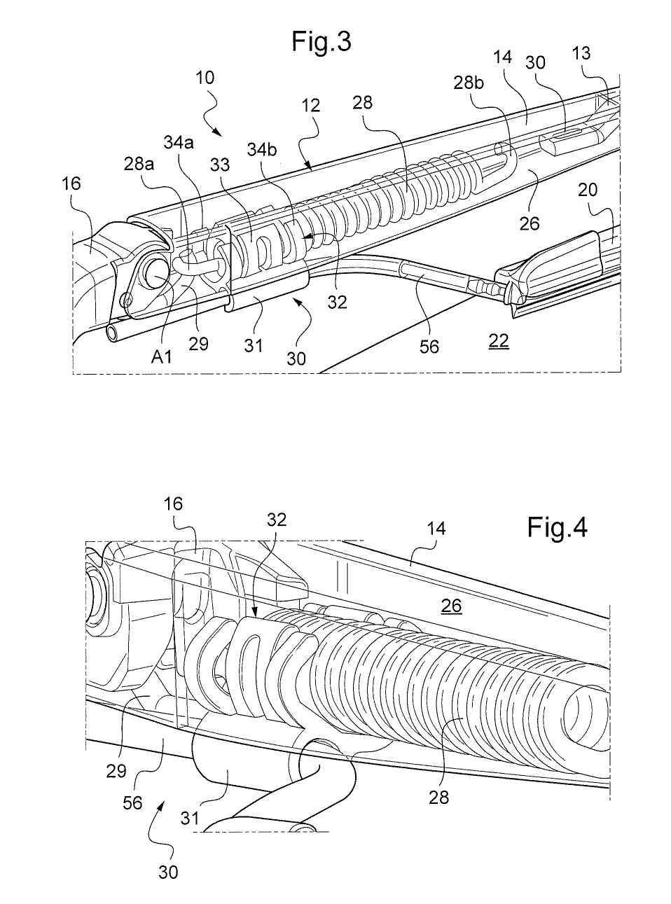

FIG. 3 represents a partial view of the transparently shown elements of the windscreen wiper of FIG. 1,

FIG. 4 is an enlarged view of a detail of FIG. 3,

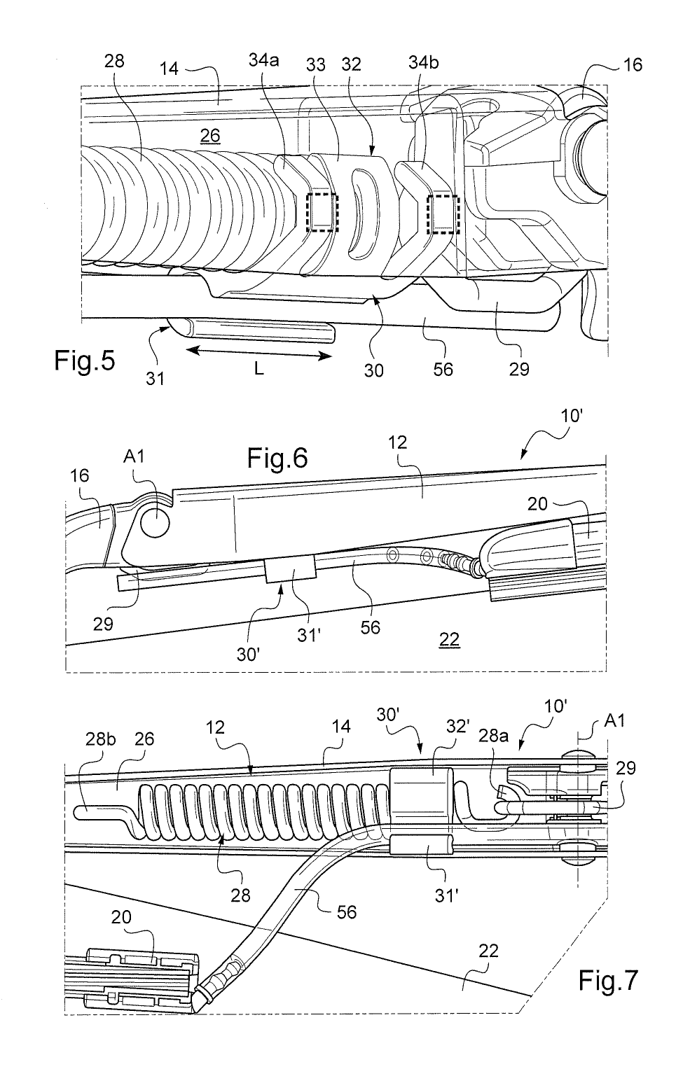

FIG. 5 is a view similar to FIG. 4 having pivoted by about 180°,

FIG. 6 illustrates a second embodiment of a windscreen wiper,

FIG. 7 represents a bottom view of the windscreen wiper of FIG. 6,

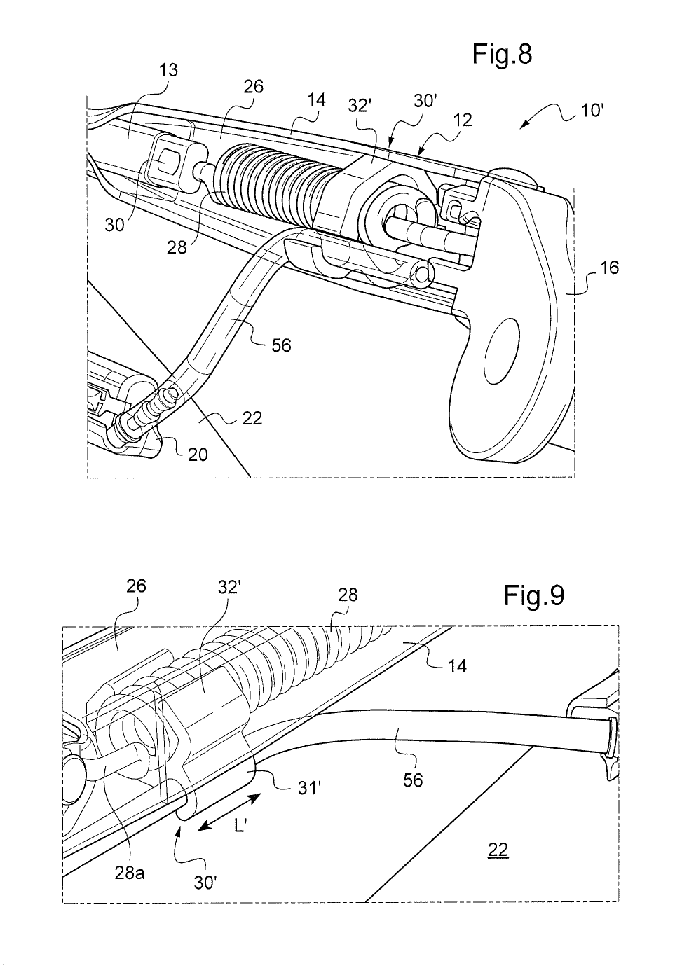

FIG. 8 represents another bottom view of the windscreen wiper of FIG. 6, and

FIG. 9 represents an enlarged view of a detail of the windscreen wiper of FIG. 6, the actuating arm being represented transparently.

In these figures, the identical elements bear the same reference numbers. To facilitate understanding, only the elements necessary to understand the invention are represented. In the remainder of the description, it will be assumed without any limitation that the longitudinal direction corresponds to the main direction of the windscreen wiper blades when flat. The “front” orientation denotes the side of the free end of the windscreen wiper when it is mounted in the vehicle.

FIGS. 1 to 5 depict a motor vehicle windscreen wiper 10 which comprises a wiper blade actuating arm 12 and a drive head 16.

The drive head 16 is fixed to the upper end of a drive shaft 18 which rotates the windscreen wiper 10 with a back and forth sweeping motion about the pivoting axis A2.

The actuating arm 12 is formed by a housing part 14 (or rear longitudinal end) and by a front longitudinal end 13 fixed to the housing part 14 by a narrowing of the housing part 14.

The windscreen wiper 10 additionally comprises a windscreen wiper blade 20 mounted at the front longitudinal end 13 of the arm 12 and which is intended to be pressed against a windscreen 22 to be wiped. The actuating arm 12 and the drive head 16 are mounted in an articulated manner about a transverse pivoting axis A1 which makes it possible to lift the actuating arm 12 from the windscreen 22 to be wiped.

The housing part 14 of the arm 12 comprises, substantially over its whole length, a cavity 26 delimited in particular by two longitudinal and parallel internal flanks. The cavity 26 forms a “U” which is open in the direction of the windscreen 22 to be wiped and which houses in particular a wiping pressure spring 28 of the windscreen wiper 10, connecting the drive head 16 to the front longitudinal end 13.

In a manner known per se, the wiping pressure spring 28 is a helical tension spring having a number of turns wound between a rear end 28a and a front end 28b, the rear end 28a and front end 28b having a seat for a hook.

More precisely with reference to FIG. 1, the rear end 28a of the wiping pressure spring 28 is attached to the drive head 16 by a hook 29 of the windscreen wiper. The front end 28b of the spring 28, situated on the opposite side, is intended to be attached to the front longitudinal end 13 which bears the windscreen wiper blade 20, being accommodated in an orifice 30 of the front longitudinal end 13.

The windscreen wiper 10 also comprises a device for spraying screen wash product (not shown) which is borne by the windscreen wiper blade 20 in this example and which is intended to be supplied with washing liquid by a flexible supply duct 56.

In a known manner, the supply duct 56 of the windscreen wiper 20 is connected to a liquid reservoir (not shown) arranged inside the vehicle.

The windscreen wiper additionally comprises a securing device 30 at least partially housed in the cavity 26 of the housing part 14 of the actuating arm 12, retaining the supply duct 56.

The securing device 30 comprises a means 31 for fixing the supply duct 56 and an elastic retaining stirrup 32 having an opening directed towards the interior of the cavity 26 and which cooperates with the outer periphery of the spring 28 in order to retain the supply duct 56 on the housing part 14 of the actuating arm 12.

The supply duct 56 mounted in the vehicle forms a loop around the drive shaft 18 below the drive head 16, and is retained on the actuating arm 12 by the securing device 30, and then is borne by the windscreen wiper blade 20.

As is more clearly visible in FIGS. 4 and 5, the retaining stirrup 32 comprises a first fork 33 and two second forks 34a, 34b. The first fork 33 is, for example, longer than the second forks 34a, 34b and is interposed between the two second forks 34a, 34b.

The first fork 33 is fitted elastically on the turns of the wiping pressure spring 28, for example around the end turns situated in the region of the rear end 28a of the spring 28 (FIGS. 1 and 3). The securing device 30 is thus arranged as closely as possible to the pivoting axis A2, thus avoiding the “pumping” effects which generate variations in the length of the supply duct 56 between the two angular end positions of the windscreen wiper during the wiping operation.

The two second forks 34a, 34b cooperate with the internal flanks of the cavity 26 by elastic deformation. More precisely, when the retaining stirrup 32 is relaxed in the cavity 26, the branches of the second forks 34a, 34b deform so as to bear against the internal flanks of the cavity 26. In addition, the backs of the branches can have planar portions substantially in the centre thereof which, once relaxed in the cavity 26, facilitate the bearing against the internal flanks of the cavity 26 (see areas represented in dashed lines in FIG. 5).

The main function of the first fork 33 is to firmly fix the securing device 30 to the actuating arm 12, avoiding translational movement along the spring 28. The second forks 34a, 34b form an anti-rotation means making it possible to prevent the securing device 30 from turning about the wiping pressure spring 28.

The means 31 for fixing the supply duct 56 is, for example, a removable fixing means, such as a clip.

According to a robust and lower-cost exemplary embodiment, the securing device 30 is produced as a single piece consisting of the retaining stirrup and of the means for fixing the supply duct, the back of the retaining stirrup 32 and the back of the clip 31 partially coinciding.

In addition, the securing device 30 has a length L of more than ten millimetres, such as of the order of 15 or 16 millimetres, thereby improving the guiding of the supply duct 56 away from the windscreen 22 to be wiped during the wiping operation, and away from the grille 15 of the vehicle in the rest position.

It is thus sufficient to clip the supply duct 56 to the securing device 30 and then to fit the retaining stirrup 32 on the wiping pressure spring 28 in order to fix the supply duct 56 to the actuating arm 12. Thus retained, the supply duct 56 is concealed and protected by a simple, rapid and inexpensive mounting.

In addition, the diameter of the turns of the wiping pressure spring 28 is very well controlled in terms of its geometry and its dimensions. A few models are sufficient to cover the majority of vehicle models. Given that the securing device 30 is fitted on the spring 28, which is virtually standard, the securing device 30 can be adapted to a large number of windscreen wipers of the range without requiring modification of the housing part.

FIGS. 6 to 9 represent a windscreen wiper 10′ comprising a securing device 30′ according to a second embodiment. In this example, only the securing device 30′ differs from the securing device 30 of the windscreen wiper 10 described in the first embodiment.

The securing device 30′ comprises a means 31′ for fixing the supply duct 56 and an elastic retaining stirrup 32′ having an opening directed towards the interior of the cavity 26. The retaining stirrup 32′ is arranged around the wiping pressure spring 28 but does not cooperate with the latter. In this second case, the retaining stirrup cooperates with the internal flanks of the cavity 26 of the housing part 14 of the arm 12 in order to retain the supply duct 56.

The elastic retaining stirrup 32′ cooperates with the internal flanks of the cavity 26 by elastic deformation. More precisely, when the retaining stirrup 32′ is relaxed in the cavity 26, the branches forming the retaining stirrup 32′ deform so as to bear against the internal flanks of the cavity 26.

Each branch forming the retaining stirrup 32′ has a shape substantially complementary to at least a part of the spring turns arranged in the vicinity of said branches. Thus, as is visible in FIGS. 8 and 9, each branch 32′ substantially forms an arc of a circle of which the angular sector is centred on the axis of the spring. Preferably, the angular sector of each branch is between 70 and 170 degrees and more particularly between 100 and 150 degrees. The elastic retaining stirrup 32′ is arranged around the spring 28, for example in the region of the end turns situated in the region of the rear end 28a of the spring 28 (FIGS. 7 and 8). The securing device 30′ is thus arranged as closely as possible to the pivoting axis A2, thus avoiding the “pumping” effects which generate variations in the length of the supply duct 56 between the two angular end positions of the windscreen wiper during the wiping operation.

In addition to the function of securing the duct 56 on the actuating arm 12, the retaining stirrup 32′ prevents the securing device 30′ from turning around the wiping pressure spring 28.

It thus suffices to clip the supply duct 56 to the securing device 30′ and then to clamp and relax the retaining strip 32′ in the cavity 26 around the spring 28 in order to fix the supply duct 56 to the housing part 14 of the actuating arm 12. Thus retained, the supply duct 56 is concealed and protected by a simple, rapid and inexpensive mounting. The invention also covers a securing device in which the elastic retaining stirrup 32 configured to cooperate with the outer periphery of a pressure spring does not cooperate with the internal flanks of the cavity 26 of the housing part of the actuating arm 12. Thus, in this embodiment, the stirrup is only retained by its cooperation with the pressure spring.

Thus, the invention relates to a device for securing a screen wash product supply duct 56 to an actuator arm 12 of a windscreen wiper blade 20 of a motor vehicle, in which the securing device comprises:
a means 31 for fixing the supply duct 56 and
an elastic retaining stirrup 32 configured to cooperate with the outer periphery of a wiping pressure spring 28 housed in a cavity 26 of the housing part 14 of the actuating arm 12 in order to retain the supply duct 56 on the actuating arm 12.

1. A device for securing a screen wash product supply duct on an actuating arm of a windscreen wiper blade of a motor vehicle, said securing device comprising:
a clip for fixing the supply duct; and
an elastic retaining stirrup configured to cooperate with the outer periphery of a wiping pressure spring housed in a cavity of the housing part of the actuating arm or configured to be arranged around a wiping pressure spring housed in the cavity of the housing part of the actuating arm and configured to cooperate with internal flanks of said cavity, in order to retain the supply duct on the actuating arm.

2. The securing device according to claim 1, wherein a part of the retaining stirrup has a shape substantially complementary to at least a part of the spring arranged in the vicinity of said stirrup.

3. The securing device according to claim 1, wherein the retaining stirrup comprises a first fork configured to fit elastically on the turns of the wiping pressure spring.

4. The securing device according to claim 3, wherein the retaining stirrup comprises an anti-rotation means.

5. The securing device according to claim 4, wherein that the anti-rotation means is formed by at least a second fork which can cooperate with the internal flanks of the cavity by elastic deformation.

6. The securing device according to claim 5, further comprising two second forks, the first fork being longer than the second forks and the first fork being interposed between the two second forks.

7. The securing device according to claim 2, wherein that-the retaining stirrup comprises a first branch substantially forming an arc of a circle, the angular sector of said arc being centered on the axis of the spring.

8. The securing device according to claim 7, wherein the retaining stirrup comprises a second branch substantially forming an arc of a circle, the angular sector of said arc preferably being centred centered on the axis of the spring.

9. The securing device according to claim 8, wherein the angular sector of said first branch and/or of said second branch is between 70 and 170 degrees, preferably between 100 and 150 degrees.

10. (canceled)

11. The securing device according to claim 1, wherein the securing device is produced as a single piece consisting of the retaining stirrup and the clip for fixing the supply duct.

12. The securing device according to claim 1, wherein the securing device comprises a length (L) of more than ten millimeters.

13. A windscreen wiper comprising:
a wiper blade actuating arm;
a supply duct of a device for spraying screen wash product; and
a securing device according to claim 1, at least partially housed in the cavity of the actuating arm, thereby retaining the supply duct on the actuating arm.

14. The windscreen wiper according to claim 13, wherein the elastic retaining stirrup is fitted elastically around the end turns of the wiping pressure spring which are situated in the a rear end of said spring attached to the drive head of the windscreen wiper.

15. The windscreen wiper according to claim 13 the elastic retaining stirrup is arranged around the end turns of the wiping pressure spring which are situated in a rear end of said spring attached to the drive head of the windscreen wiper.
